(19) United States
(12) Patent Application Publication
(10) Pub. No.: US 2013/0233496 A1
(43) Pub. Date: Sep. 12, 2013

(54) MOTORIZED WINDOW TREATMENT HAVING A BELT DRIVE

(71) Applicants: Peter W. Ogden, JR., Breinigsville, PA (US); Justin M. Zernhelt, Northampton, PA (US)

(72) Inventors: Peter W. Ogden, JR., Breinigsville, PA (US); Justin M. Zernhelt, Northampton, PA (US)

(21) Appl. No.: 13/415,289

(22) Filed: Mar. 8, 2012

(51) Int. Cl. A47H 5/02; E06B 9/322; F16H 7/18; A47H 23/04

(52) U.S. Cl. 160/84.02; 160/331; 160/168.1 P; 474/148

(57) ABSTRACT

A battery-powered motorized window treatment for controlling the position of a covering material includes a motor drive unit having a belt drive. The motor drive includes a motor for rotating a drive shaft to thus raise and lower the covering material and is powered by one or more batteries. The belt drive includes a belt that surrounds a first pulley coupled to the motor and a second pulley, which operates to rotate the drive shaft. The belt drive isolates noise generated by the motor from the gears and parts of the motor drive unit and the motorized window treatment. The belt drive includes rollers for holding the belt on the pulleys, and the belt is sized to reduce the load on the motor, such that the motor draws less current from the batteries. As a result, the batteries have a much longer lifetime than those of a typical prior art battery-powered motorized window treatment.

### BACKGROUND OF THE INVENTION

1. Field of the Invention

The present invention relates to a motorized window treatment, and more specifically, to a low-cost, quiet, battery-powered motorized window treatment having a belt drive that reduces the noise generated by the motorized window treatment and reduces the current draw by a motor from batteries of the motorized window treatment.

2. Description of the Related Art

Motorized window treatments typically include a flexible fabric or other means for covering a window in order to block or limit the daylight entering a space and to provide privacy. The motorized window treatments may comprise roller shades, cellular shades, Roman shades, Venentian blinds, and draperies. The motorized window treatments include a motor drive for movement of the fabric in front of the window to control the amount of the window that is covered by the fabric. For example, a motorized roller shade includes a flexible shade fabric wound onto an elongated roller tube with an electronic drive unit installed in the roller tube. The electronic drive unit includes a motor, such as a direct-current (DC) motor, which is operable to rotate the roller tube upon being energized by a DC voltage.

Prior art electronic drive units are typically powered directly from an AC mains line voltage (e.g., 120 VAC) or from a low-voltage DC voltage (e.g., approximately 24 VDC) provided by an external transformer. Unfortunately, this requires that electrical wires to be run from the power source to the electronic drive unit. Running additional AC main line voltage wiring to the electronic drive unit can be very expensive, due to the cost of the additional electrical wiring as well as the cost of installation. Typically, installing new AC main line voltage wiring requires a licensed electrician to perform the work. In addition, if the pre-existing wiring runs behind a fixed ceiling or wall (e.g., one comprising plaster or expensive hardwood), the electrician may need to breach the ceiling or wall to install the new electrical wiring, which will thus require subsequent repair. In some installations where low voltage (e.g., from a low-voltage DC transformer) is used to the power the electronic drive unit, the electrical wires have been mounted on an external surface of a wall or ceiling between the electronic drive unit and the transformer, which is plugged into an electrical receptacle. However, this sort of installation requires the permanent use of one of the outlets of the electrical receptacle and is aesthetically unpleasing due to the external electrical wires.

Therefore, some prior art motorized window treatments have been battery powered, such that the motorized window treatments may be installed without requiring any additional wiring. Examples of prior art battery-powered motorized window treatments are described in greater detail in U.S. Pat. No. 5,883,480, issued Mar. 16, 1999, entitled WINDOW COVERING WITH HEAD RAIL-MOUNTED ACTUATOR; U.S. Pat. No. 5,990,646, issued Nov. 23, 2009, entitled REMOTELY-CONTROLLED BATTERY POWERED-WINDOW COVERING HAVING POWER SAVING RECEIVER; and U.S. Pat. No. 7,389,806, issued Jun. 24, 2008, entitled MOTORIZED WINDOW SHADE SYSTEM; the entire disclosures of which are hereby incorporated by reference.

However, the typical prior art battery-powered motorized window treatments have suffered from poor battery life (such as, one year or less), and have required batteries that are difficult and expensive to replace. Thus, there is a need for a quiet, low-cost battery-powered motorized window treatment that has longer battery life.

### SUMMARY OF THE INVENTION

The present invention provides a low-cost, quiet, battery-powered motorized window treatment for controlling the position of a covering material that is adapted to hang in front of an opening, such as a window. The motorized window treatment comprises a motor drive unit having a motor for rotating a drive shaft to thus raise and lower the covering material and batteries for powering the motor drive unit. The motor drive unit includes a belt drive that isolates noise generated by the motor from the gears and parts of the motor drive unit and the motorized window treatment. The belt drive includes a belt that is coupled between two pulleys and is sized to reduce the load on the motor, such that the motor draws less current from the batteries. As a result, the batteries have a much longer (and more practical) lifetime (e.g., approximately three years) than those of a typical prior art battery-powered motorized window treatment.

According to an embodiment of the present invention, a motor drive unit for a motorized window treatment comprises a motor having an output shaft, a first pulley coupled to the output shaft of the motor, a second pulley, and a flexible belt surrounding the first and second pulleys. The second pulley is coupled such that rotations of the second pulley result in rotations of a drive shaft of the motorized window treatment. At least one lift is rotatably received around the drive shaft and extends to a bottom of a covering material for raising and lowering the covering material between a fully-open and fully-closed position and to any position intermediate the fully-open and fully-closed positions. The flexible belt is coupled to the first and second pulleys, such that rotations of the motor and the first pulley result in rotations of the second pulley, and thus the drive shaft, so as to raise and lower the covering material by rotating the motor.

In addition, a gear assembly for a motor drive unit is also described herein. The gear assembly comprises: (1) an end portion; (2) a first pulley adapted to be coupled to an output shaft of a motor adjacent the end portion and to rotate with respect to the end portion; (3) a second pulley; (4) a flexible belt surrounding the first and second pulleys, such that rotations of the motor and the first pulley result in rotations of the second pulley, the belt having teeth adapted to engage teeth of the first and second pulleys; and (5) a first roller rotatably coupled to the end portion and contacting an outer surface of the belt. The first roller holds the belt against the first pulley to ensure that the belt and the first pulley have at least a predetermined angular contact length.

According to another embodiment of the present invention, a motorized window treatment comprises a covering material, a drive shaft, at least one lift cord rotatably received around the drive shaft and extending to a bottom end of the covering material, a motor drive unit having a motor comprising an output shaft, and at least one battery for powering the motor drive unit. The motor drive unit is coupled to the drive shaft for raising and lowering the covering material in response to rotations of the motor. The motor drive unit further comprises a first pulley coupled to the output shaft of the motor, a second pulley coupled such that rotations of the second pulley result in rotations of the drive shaft, and a flexible belt surrounding the first and second pulleys, such that rotations of the motor and the first pulley result in rotations of the second pulley, and thus the drive shaft, so as to raise and lower the covering material by rotating the motor.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a perspective view of a motorized window treatment system having a battery-powered motorized window treatment and a remote control according to a first embodiment of the present invention;

FIG. 2 is a perspective view of the battery-powered motorized window treatment of FIG. 1 in a full-opened position;

FIG. 3 is a right side view of the battery-powered motorized window treatment of FIG. 1;

FIG. 4 is a front view of the battery-powered motorized window treatment of FIG. 1;

FIG. 5 is an exploded view of a motor drive unit of the battery-powered motorized window treatment of FIG. 1;

FIG. 6 is an enlarged perspective view of a motor and a gear assembly of the motor drive unit of FIG. 5 showing a belt drive of the motor in greater detail;

FIG. 7 is a left side view of a belt drive of the gear assembly of FIG. 6;

FIG. 8 is a front cross-sectional view of the belt drive of the gear assembly of FIG. 6;

FIG. 9 is a simplified block diagram of a motor drive unit of the battery-powered motorized window treatment of FIG. 1;

FIG. 10 is a simplified partial schematic diagram of an H-bridge motor drive circuit and a motor of the motor drive unit of FIG. 9;

FIG. 11 is a diagram of a first output signal and a second output signal of a transmissive optical sensor circuit of FIG. 9;

FIG. 12 is a simplified flowchart of a transmissive optical sensor edge procedure executed periodically by the controller of the motor drive unit of FIG. 9; and

FIG. 13 is a simplified flowchart of a motor control procedure executed periodically by the controller of the motor drive unit of FIG. 9.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

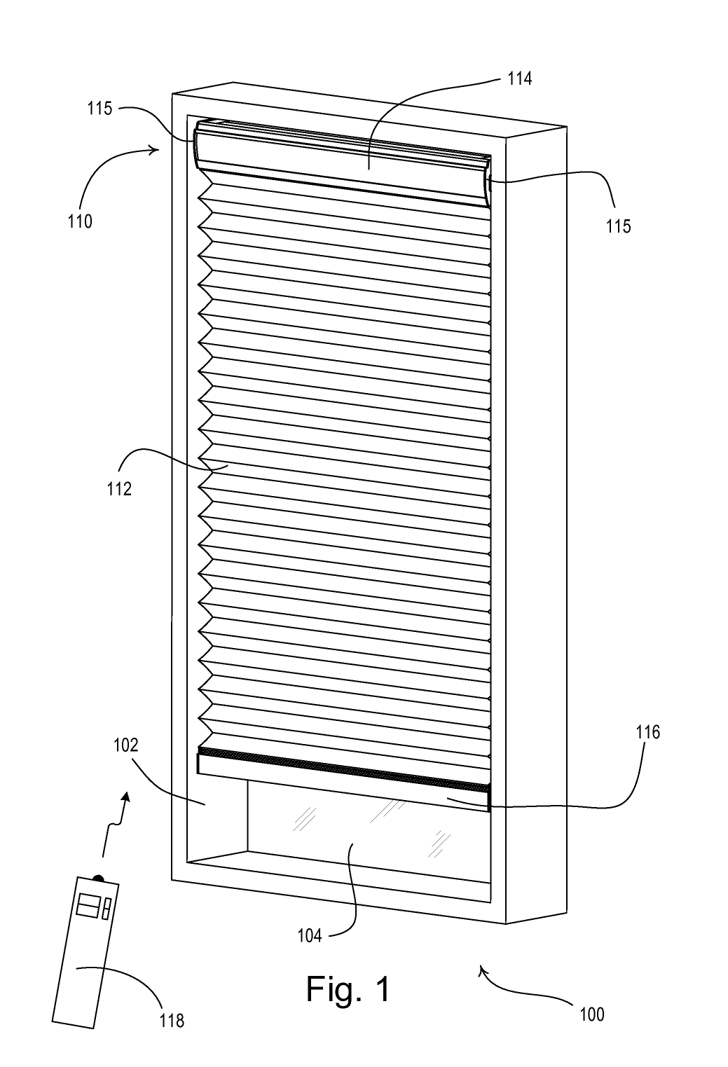

FIG. 1 is a perspective view of a motorized window treatment system 100 having a battery-powered motorized window treatment 110 mounted in an opening 102, for example, in front of a window 104, according to a first embodiment of the present invention. The battery-powered motorized window treatment 110 comprises a covering material, for example, a cellular shade fabric 112 as shown in FIG. 1. The cellular shade fabric 112 has a top end connected to a headrail 114 (that extends between two mounting plates 115) and a bottom end connected to a weighting element 116. The mounting plates 115 may be connected to the sides of the opening 102 as shown in FIG. 1, such that the cellular shade fabric 112 is able to hang in front of the window 104, and may be adjusted between a fully-open position P_{FULLY-OPEN} and a fully-closed position P_{FULLY-CLOSED} to control the amount of daylight entering a room or space. Alternatively, the mounting plates 115 of the battery-powered motorized window treatment 110 could be mounted externally to the opening 102 (e.g., above the opening) with the shade fabric 112 hanging in front of the opening and the window 104. In addition, the battery-powered motorized window treatment 110 could alternatively comprise other types of covering materials, such as, for example, a plurality of horizontally-extending slats (i.e., a Venetian or Persian blind system), pleated blinds, a roller shade fabric, or a Roman shade fabric. According to the first embodiment of the present invention, the motorized window treatment system 100 comprises an infrared (IR) remote control 118 for controlling the operation of the motorized window treatment 110.

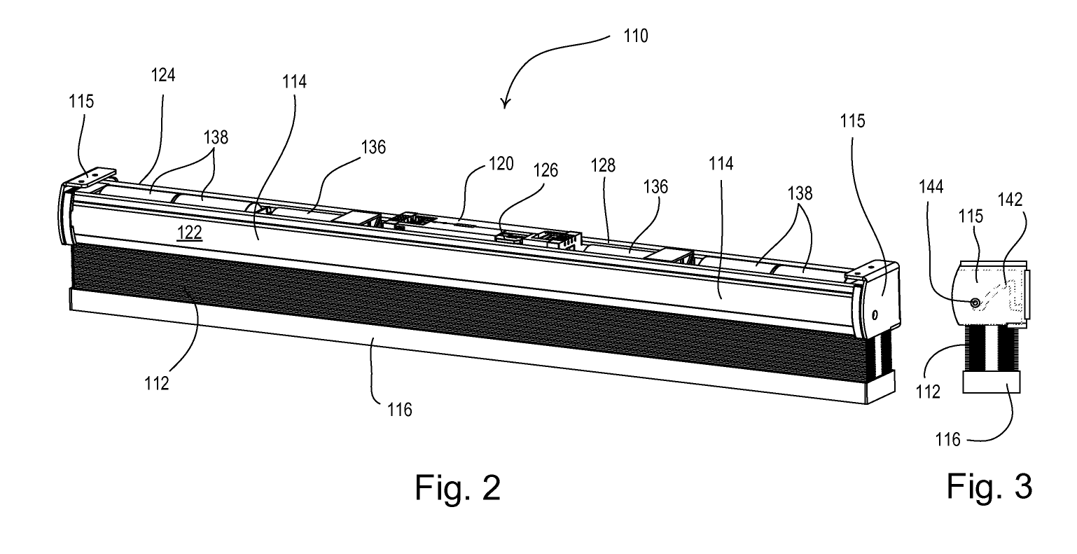

FIG. 2 is a perspective view and FIG. 3 is a right side view of the battery-powered motorized window treatment 110 with the cellular shade fabric 112 in the fully-open position P_{FULLY-OPEN}. The motorized window treatment 110 comprises a motor drive unit 120 for raising and lowering the weighting element 116 and the cellular shade fabric 112 between the fully-open position P_{FULLY-OPEN} and the fully-closed position P_{FULLY-CLOSED}. By controlling the amount of the window 104 covered by the cellular shade fabric 112, the motorized window treatment 110 is able to control the amount of daylight entering the room. The headrail 114 of the motorized window treatment 110 comprises an internal side 122 and an opposite external side 124, which faces the window 104 that the shade fabric 112 is covering.

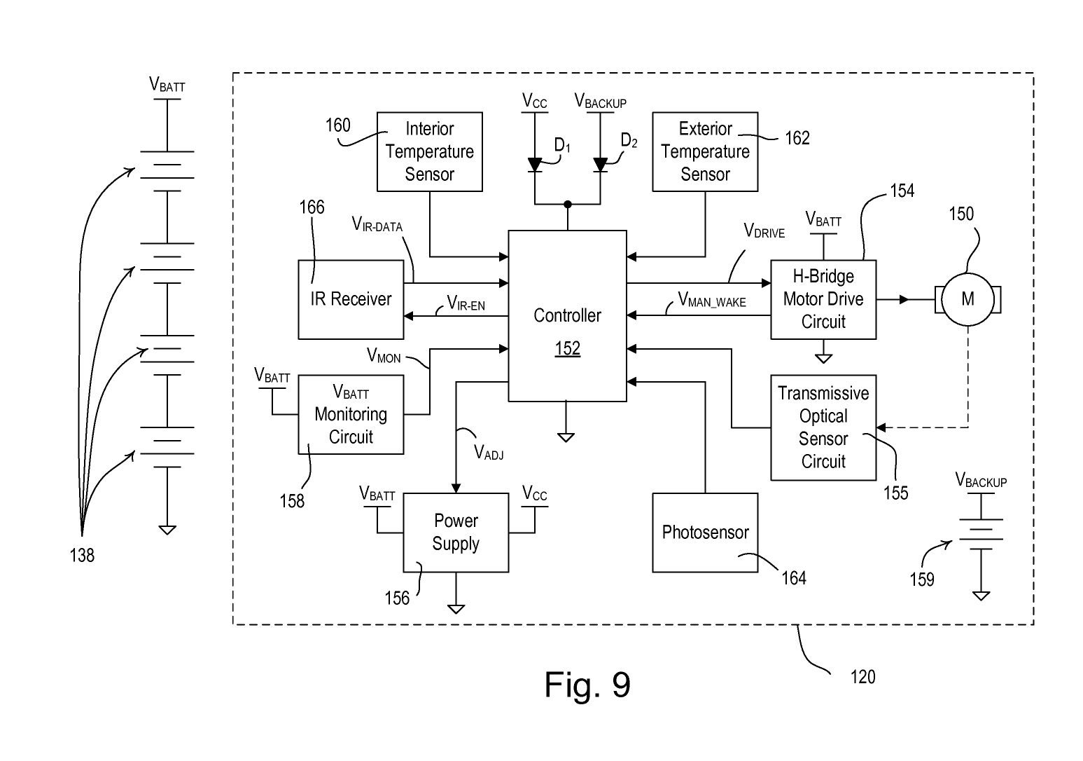

The motor drive unit 120 comprises an actuator 126, which is positioned adjacent the internal side 122 of the headrail 114 may be actuated when a user is configuring the motorized window treatment 110. The actuator 126 may be made of, for example, a clear material, such that the actuator may operate as a light pipe to conduct illumination from inside the motor drive unit 120 to thus be provide feedback to the user of the motorized window treatment 110. In addition, the actuator 126 may also function as an IR-receiving lens for directing IR signals transmitted by the IR remote control 118 to an IR receiver 166 (FIG. 9) inside the motor drive unit 120. The motor drive unit 120 is operable to determine a target position P_{TARGET} for the weighting element 116 in response to commands included in the IR signals received from the remote control 118 and to subsequently control a present position P_{PRES} of the weighting element to the target position P_{TARGET}. As shown in FIG. 2, a top side 128 of the headrail 114 is open, such that the motor drive unit 120 may be positioned inside the headrail and the actuator 126 may protrude slightly over the internal side 122 of the headrail.

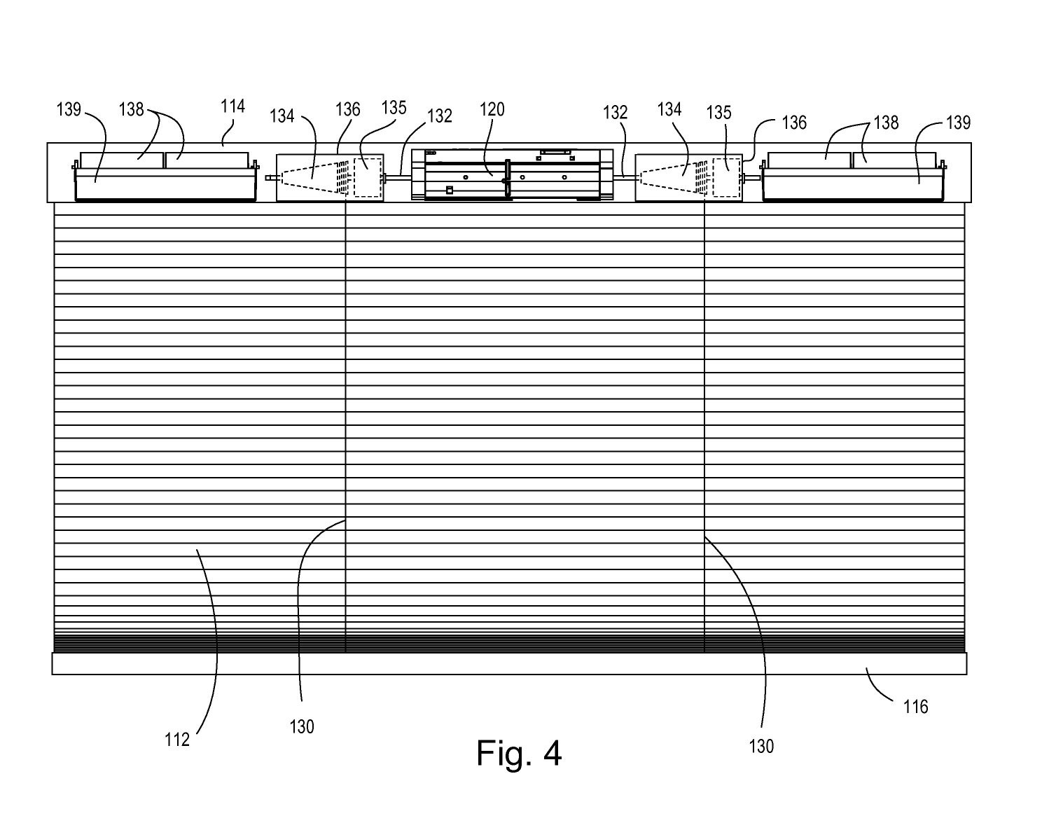

The battery-powered motorized window treatment 110 also comprises a plurality of batteries 138 (e.g., four D-cell batteries), which are electrically coupled in series. The series-combination of the batteries 138 is coupled to the motor drive unit 120 for powering the motor drive unit. The batteries 138 are housed inside the headrail 114 and thus out of view of a user of the motorized window treatment 110. Specifically, the batteries 138 are mounted in two battery holders 139 located inside the headrail 114, such that there are two batteries in each battery holder as shown in FIG. 4. According to the embodiments of the present invention, the batteries 138 provide the motorized window treatment 110 with a practical lifetime (e.g., approximately three years), and are typical “off-the-shelf” batteries that are easy and not expensive to replace. Alternatively, the motor drive unit 120 could comprise more batteries (e.g., six or eight) coupled in series or batteries of a different kind (e.g., AA batteries) coupled in series.

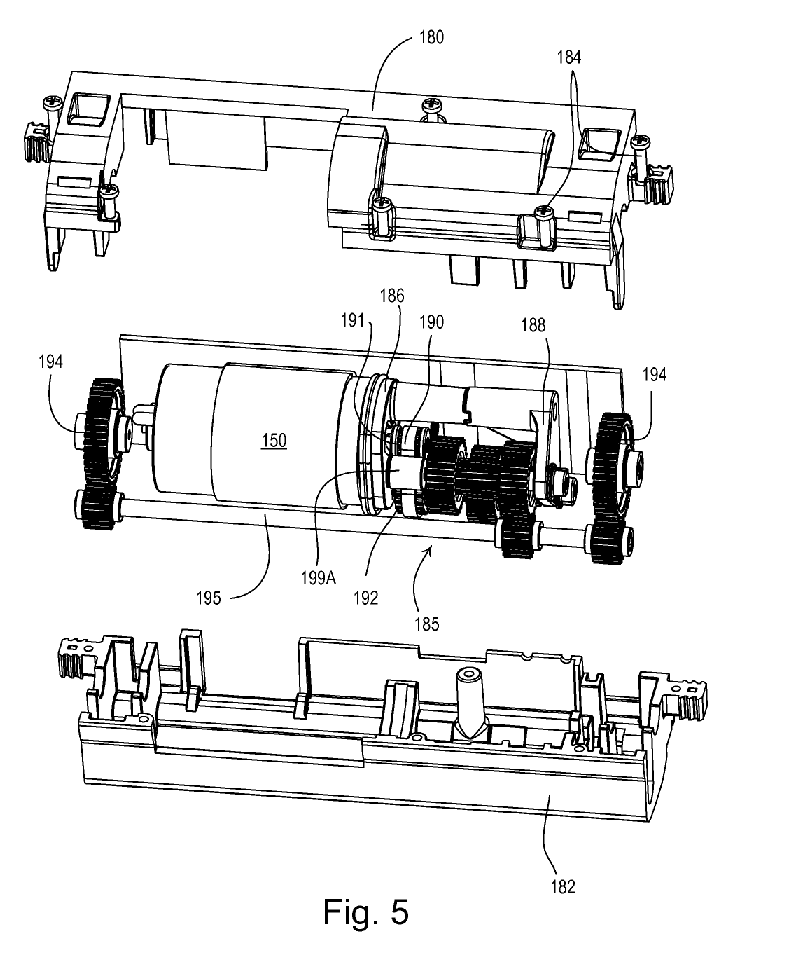

FIG. 4 is a front view of the battery-powered motorized window treatment 110 with a front portion of the headrail 114 removed to show the motor drive unit 120. The motorized window treatment 110 comprises lift cords 130 that extend from the headrail 114 to the weighting element 116 for allowing the motor drive unit 120 to raise and lower the weighting element. The motor drive unit 120 includes an internal motor 150 (FIG. 5) coupled to drive shafts 132 that extend from the motor on each side of the motor and are each coupled to a respective lift cord spool 134. The lift cords 130 are windingly received around the lift cord spools 134 and are fixedly attached to the weighting element 116, such that the motor drive unit 120 is operable to rotate the drive shafts 132 to raise and lower the weighting element. The motorized window treatment 110 further comprises two constant-force spring assist assemblies 135, which are each coupled to the drive shafts 132 adjacent to one of the two lift cord spools 134. Each of the lift cord spools 134 and the adjacent constant-force spring assist assembly 135 are housed in a respective lift cord spool enclosure 136 as shown in FIG. 4. Alternatively, the motor drive unit 120 could be located at either end of the headrail 114 and the motorized window treatment 110 could comprise a single drive shaft that extends along the length of the headrail and is coupled to both of the lift cord spools 134.

FIG. 5 is an exploded view of the motor drive unit 120. The motor drive unit 120 comprises two enclosure portions 180, 182 for housing the motor 150 and a gear assembly 185. The two enclosure portions 180, 182 are connected and held together by a plurality of screws 184. The gear assembly 190 is held together by two end portions 186, 188 and comprises a belt drive, and specifically, a belt 190 coupled between a first pulley 191 that is coupled to the output shaft of the motor 150 and a second pulley 192 that is coupled to the other gears of the gear assembly. The motor drive unit 120 comprises output gears 194 that are located on both sides of the motor drive unit and are coupled to the drive shafts 132. The gear assembly 185 is coupled to the output gears 194 via a coupling member 195, such that the rotations of the output shaft of the motor 150 result in rotations of the drifts shafts 132.

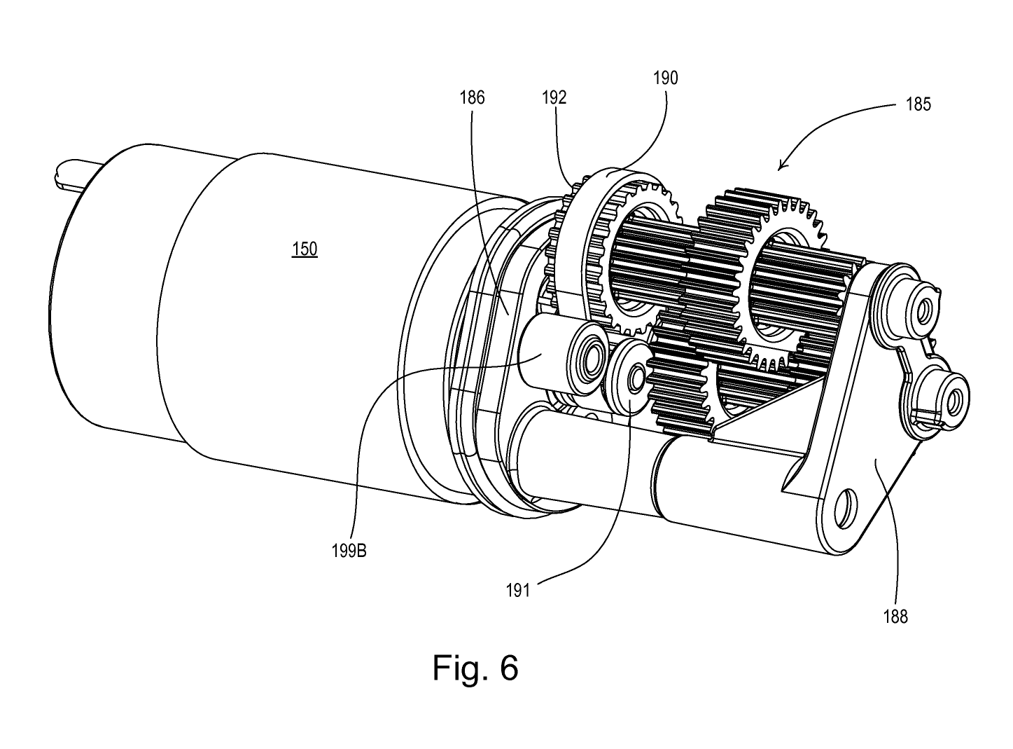

FIG. 6 is an enlarged perspective view of the motor 150 and the gear assembly 185 showing the belt drive in greater detail. For example, the belt 190 may comprise a flexible toothed belt having teeth 196 (FIG. 8) that engage teeth 198 (FIG. 8) of the first and second pulleys 191, 192. For example, the outside diameter of the first and second pulleys 191, 192 may be approximately 0.235 inch and 0.591 inch, respectively, resulting in a gear ratio of approximately 2:5. Since the second pulley 192 is coupled to the first pulley 191 via the flexible belt 190, noises generated by the rotations of the motor 150 are not coupled from the first pulley 191 to the second pulley 192. Accordingly, the total noise generated by the gear assembly 185 is reduced.

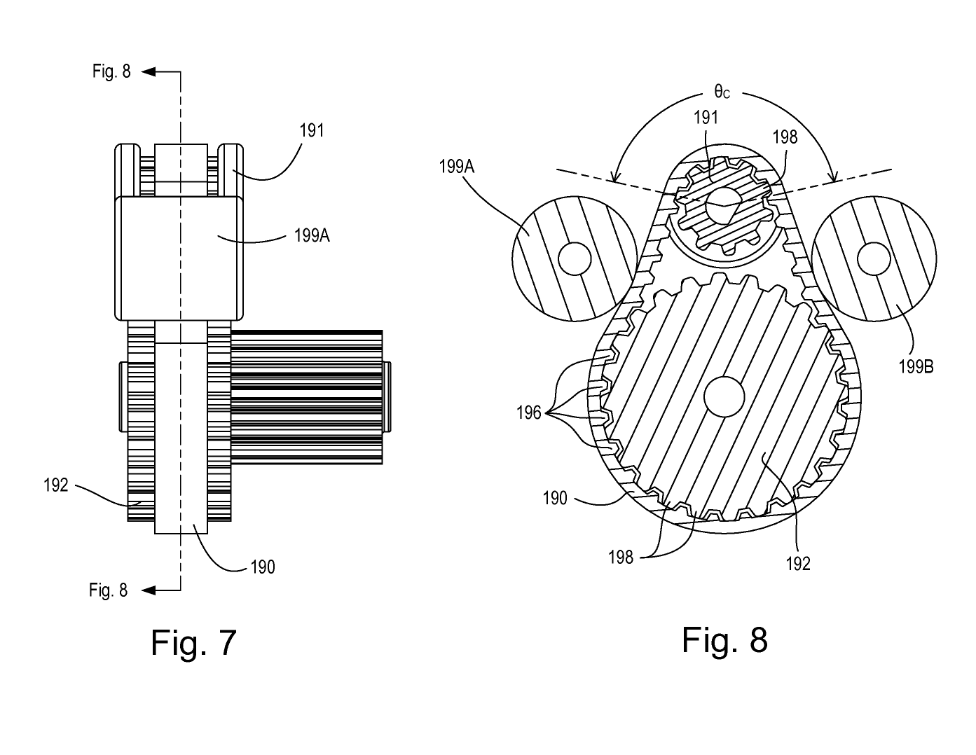

The gear assembly 185 further comprises a first roller 199A (FIG. 4A) and a second roller 199B (FIG. 6) that are rotatably coupled to the end portion 186 that is located adjacent the motor 150. FIG. 7 is a left side view of the belt 190, the first and second pulleys 191, 192, and one of the rollers 199A. FIG. 8 is a front cross-sectional view of the belt 190, the first and second pulleys 191, 192, and the rollers 199A, 199B taken through the center of the belt 190 as shown in FIG. 7. The belt 190 contacts the rollers 199A, 199B, which operate to hold the belt against the first and second pulleys 191, 192 and to ensure that the belt and the first gear have an appropriate angular contact length θ_{C} (e.g., approximately 136°) as shown in FIG. 8. For example, if the rollers 199A, 199B are not provided in the motor drive unit 120, the belt 190 may have an angular contact length θ_{c} with the first pulley 192 of approximately 30°. With the rollers 199A, 199B installed in the gear assembly 185, the belt 190 can have a larger diameter than if the rollers were not provided and still achieve the appropriate angular contact length θ_{C} between the belt and the first pulley 191. It was discovered that loosening the belt 190 and providing the rollers 199A, 199B led to a decreased current consumption in the motor 150 as compared to when the rollers were not provided, the belt was tighter, and the same angular contact length θ_{C} between the belt 190 and the first pulley 191 was achieved (i.e., approximately 136°). In addition, the diameters of the rollers 199A, 199B can be adjusted to change the angular contact length θ_{C}.

FIG. 9 is a simplified block diagram of the motor drive unit 120 of the battery-powered motorized window treatment 110. The motor drive unit 120 comprises a controller 152 for controlling the operation of the motor 150, which may comprise, for example, a DC motor. The controller 152 may comprise, for example, a microprocessor, a programmable logic device (PLD), a microcontroller, an application specific integrated circuit (ASIC), a field-programmable gate array (FPGA), or any suitable processing device or control circuit. The controller 152 is coupled to an H-bridge motor drive circuit 154 for driving the motor 150 via a set of drive signals V_{DRIVE} to control the weighting element 116 and the cellular shade fabric 112 between the fully-open position P_{FULLY-OPEN} and the fully-closed position P_{FULLY-CLOSED}. The controller 152 is operable to rotate the motor 150 at a constant rotational speed by controlling the H-bridge motor drive circuit 154 to supply a pulse-width modulated (PWM) drive signal having a constant duty cycle to the motor. The controller 152 is able to change the rotational speed of the motor 150 by adjusting the duty cycle of the PWM signal applied to the motor and to change the direction of rotation of the motor by changing the polarity of the PWM drive signal applied to the motor.

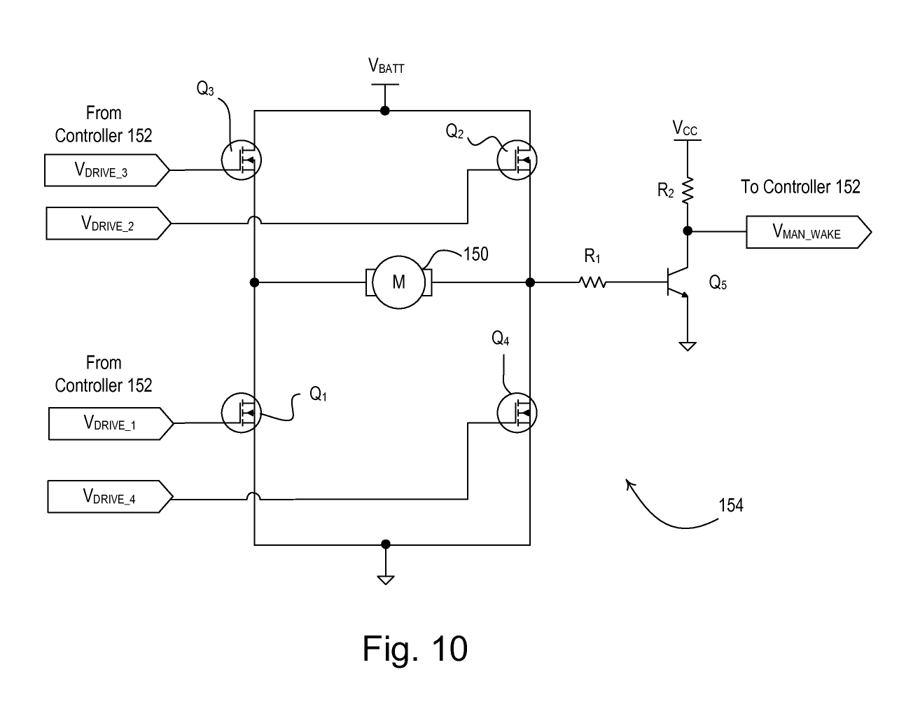

FIG. 10 is a simplified schematic diagram of the H-bridge motor drive circuit 154. The H-bridge motor drive circuit 154 may comprise four transistors, such as, for example, four field effect transistors (FETs) Q₁, Q₂, Q₃, Q₄. Each FET Q₁-Q₄ may be driven by the controller 152 via four respective drives signals V_{DRIVE}_{_{—}}₁, V_{DRIVE}_{_{—}}₂, V_{DRIVE}_{_{—}}₃, V_{DRIVE}_{_{—}}₄. The FETs Q₁-Q₄ are coupled such that, when two of the FETs are conductive (e.g., FETs Q₃, Q₄), a positive DC voltage is applied to the motor 150 to cause the DC motor to rotate in a clockwise direction. When the other two FETs of the H-bridge circuit 154 are conductive (e.g., FETs Q₁, Q₂), a negative DC voltage is applied to the motor 150 to cause the motor to rotate in the reverse (i.e., counter-clockwise) direction. To control the speed of the motor 150, the controller 152 drives at least one of FETs of the H-bridge circuit 154 with a PWM control signal. When the motor 150 is idle (i.e., at rest), the controller 152 drives only the FET Q₁ to be conductive and controls FETs Q₂, Q₃ and Q₄ to be non-conductive.

Referring back to FIG. 9, the controller 152 receives information regarding the rotational position and direction of rotation of the motor 150 from a rotational position sensor, such as, for example, a transmissive optical sensor circuit 155. The rotational position sensor may also comprise other suitable position sensors or sensor arrangements, such as, for example, Hall-effect, optical, or resistive sensors. The controller 152 is operable to determine a rotational position of the motor 150 in response to the transmissive optical sensor circuit 155, and to use the rotational position of the motor to determine a present position P_{PRES} of the weighting element 116. The controller 152 may comprise an internal non-volatile memory (or alternatively, an external memory coupled to the controller) for storage of the present position P_{PRES} of the shade fabric 112, the fully open position P_{FULLY-OPEN}, and the fully closed position P_{FULLY-CLOSED}.

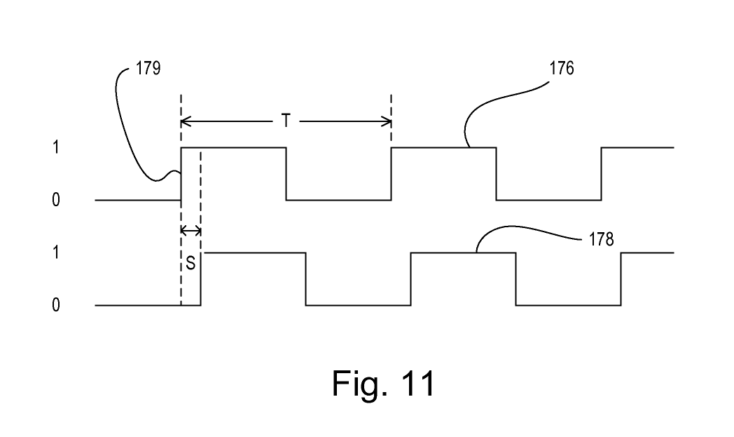

FIG. 11 is a timing diagram of a first output signal 176 and a second output signal 178 of the transmissive optical sensor circuit 155. The output signals 176, 178 are provided to the controller 152 as a train of pulses. The frequency, and thus the period T, of the pulses of the output signals 176, 178 is a function of the rotational speed of the motor output shaft 172. The relative spacing S between the pulses of the first and second output signals 176, 178 is a function of rotational direction. When the motor 150 is rotating in a clockwise direction of the output shaft 172, the second output signal 178 lags behind the first output signal 176 by the relative spacing S. When the motor 150 is rotating in the opposite direction, the second output signal 178 leads the first output signal 176 by the relative spacing S.

The controller 152 stores the present position P_{PRES} of the weighting element 116 in the memory as a number of optical sensors edges between the present position P_{PRES} of the weighting element and the fully-open position P_{FULLY-OPEN}. An optical sensor edge is, for example, the low-to-high transition 179 of the first output signal 176 as shown in FIG. 11. The operation of the H-bridge motor drive circuit 154 and the use of sensor devices to track the direction and speed of the motor drive unit 120 is described in greater detail in commonly-assigned U.S. Pat. No. 5,848,634, issued Dec. 15, 1998, entitled MOTORIZED WINDOW SHADE SYSTEM, and commonly-assigned U.S. Pat. No. 6,497,267, issued Dec. 24, 2002, entitled MOTORIZED WINDOW SHADE WITH ULTRAQUIET MOTOR DRIVE AND ESD PROTECTION, the entire disclosures of which are herein incorporated by reference.

Referring back to FIG. 10, the H-bridge motor drive circuit 154 is operable to provide a manual movement wake-up signal V_{MAN}_{_{—}}_{WAKE} to the controller 152. In the event that the cellular shade fabric 112 is moved manually, the motor 150 can be back-driven and provide the manual movement wake-up signal V_{MAN}_{_{—}}_{WAKE} to the controller 152. The manual movement wake-up signal V_{MAN}_{_{—}}_{WAKE} indicates that the cellular shade fabric 112 is being moved manually (i.e., pulled by a user), and the signal can cause the controller 152 to wake up (i.e., become fully energized) in the event that the controller is sleeping (i.e., operating in a low power mode). Thus, the controller 152 can continue to monitor the output of the transmissive optical sensor circuit 155. As shown in FIG. 10, one terminal of the motor 150 is coupled to the base of an NPN bipolar junction transistor Q₅ via a resistor R₁. The collector of the transistor Q₅ is coupled to the supply voltage V_{CC} via a resistor R₂. The manual movement wake-up signal V_{MAN}_{_{—}}_{WAKE} is generated at the junction of the collector of the transistor Q₅ and the resistor R₂, which is coupled to the controller 152. When the motor 150 is rotated in response to a manual action, a back electromagnetic force (EMF) is generated across the motor 150 and the transistor Q₅ becomes conductive, thus driving the manual movement wake-up signal V_{MAN}_{_{—}}_{WAKE} low. The controller 152 may be operable to wake-up automatically in response to detecting such a high-to-low transition on one of its input ports.

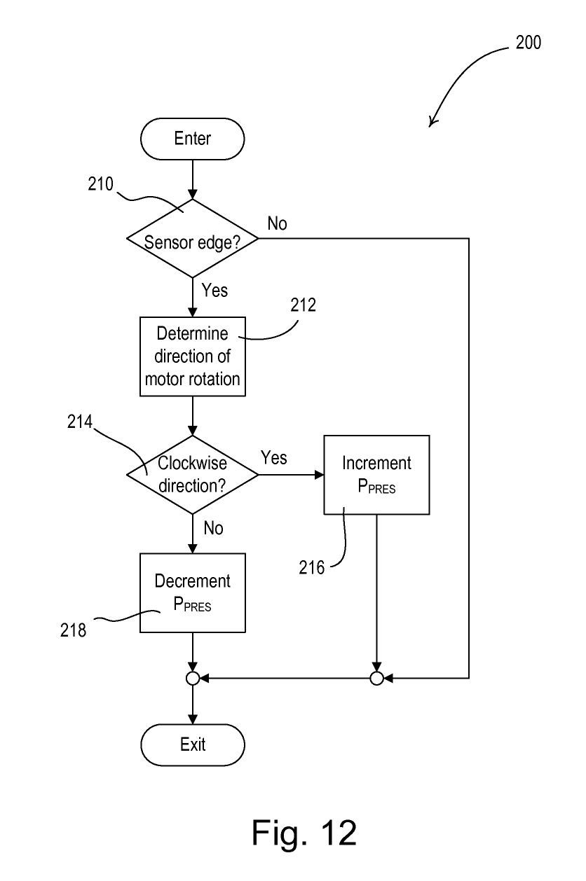

Once the controller 152 wakes up in response to the manual movement wake-up signal V_{MAN}_{_{—}}_{WAKE}, the controller 152 monitors the output of the transmissive optical sensor circuit 155 to track the position of the motor 150 by executing a transmissive optical sensor edge procedure 200, which will be discussed in greater detail below with reference to FIG. 12. In addition, the controller 152 may further wake-up periodically (e.g., once each second) to execute the transmissive optical sensor edge procedure 400 to determine whether the cellular shade fabric 112 is moving or has moved as a result of a manual adjustment.

FIG. 12 is a simplified flowchart of the transmissive optical sensor edge procedure 200 executed periodically by the controller 152, e.g., every 10 msec, to determine the rotational position and direction of the motor. In addition, the transmissive optical sensor edge procedure 200 may be executed by the controller 152 in response to receiving the manual movement wake-up signal V_{MAN}_{_{—}}_{WAKE}. If the controller 152 has not received a transmissive optical sensor edge at step 210, the transmissive optical sensor edge procedure 200 simply exits. However, if the controller 152 has received a transmissive optical sensor edge from the transmissive optical sensor circuit 155 at step 210, the controller determines the direction of rotation of the motor 150 by comparing the consecutive edges of the first and second output signals 176, 178 at step 212. If the motor 150 is rotating in the clockwise direction at step 214, the controller 152 increments the present position P_{PRES} (i.e., in terms of transmissive optical sensor edges) by one at step 216. If the motor 150 is rotating in the counter-clockwise direction at step 214, the controller 152 decrements the present position P_{PRES} by one at step 218. After the present position P_{PRES} is incremented or decremented at steps 216 and 218, respectively, the transmissive optical sensor edge procedure 200 exits.

A user of the window treatment system 100 is able to adjust the position of the weighting element 116 and the cellular shade fabric 112 by using the remote control 118 to transmit commands to the motor drive unit 120 via the IR signals. Referring back to FIG. 9, the IR receiver 166 receives the IR signals and provides an IR data control signal V_{IR-DATA} to the controller 152, such that the controller is operable to receive the commands from the remote control 118. The controller 152 is operable to put the IR receiver 166 to sleep (i.e., disable the IR receiver) and to periodically wake the IR receiver up (i.e., enable the IR receiver) via an IR enable control signal V_{IR-EN}, as will be described in greater detail below. An example of an IR control system is described in greater detail in U.S. Pat. No. 6,545,434, issued Apr. 8, 2003, entitled MULTI-SCENE PRESET LIGHTING CONTROLLER, the entire disclosure of which is hereby incorporated by reference. Alternatively, the IR receiver 166 could comprise a radio-frequency (RF) receiver or transceiver for receiving RF signals transmitted by an RF remote control. Examples of RF control systems are described in greater detail in commonly-assigned U.S. patent application Ser. No. 12/033,223, filed Feb. 19, 2008, entitled COMMUNICATION PROTOCOL FOR A RADIO-FREQUENCY LOAD CONTROL SYSTEM, and U.S. patent application Ser. No. 13/415,084 filed Mar. 8, 2012, entitled MOTORIZED WINDOW TREATMENT, the entire disclosures of which are hereby incorporated by reference.

As previously mentioned, the motor drive unit 120 receives power from the series-coupled batteries 138, which provide a battery voltage V_{BATT}. For example, the batteries 138 may comprise D-cell batteries having rated voltages of approximately 1.5 volts, such that the battery voltage V_{BATT} has a magnitude of approximately 6 volts. The H-bridge motor drive circuit 154 receives the battery voltage V_{BATT} for driving the motor 150. In order to preserve the life of the batteries 138, the controller 152 may be operable to operate in a sleep mode when the motor 150 is idle.

The motor drive unit 120 further comprises a power supply 156 (e.g., a linear regulator) that receives the battery voltage V_{BATT} and generates a DC supply voltage V_{CC} for powering the controller 152 and other low-voltage circuitry of the motor drive unit. The controller 152 is coupled to the power supply 156 and generates a voltage adjustment control signal V_{ADJ} for adjusting the magnitude of the DC supply voltage V_{CC} between a first nominal magnitude (e.g., approximately 2.7 volts) and a second increased magnitude (e.g., approximately 3.3 volts). The power supply 156 may comprise, for example, an adjustable linear regulator having one or more feedback resistors that are switched in and out of the circuit by the controller 152 to adjust the magnitude of the DC supply voltage V_{CC}. The controller 152 may adjust the magnitude of the DC supply voltage V_{CC} to the second increased magnitude while the controller is driving the FETs Q₁-Q₄ of the motor drive circuit 154 to rotate the motor 150 (since the controller may require an increased supply voltage to drive the gates of the FETs). The controller 152 adjusts the magnitude of the DC supply voltage V_{CC} to the first nominal magnitude when the controller is not controlling the motor drive circuit 154 to rotate the motor 150 (e.g., when the controller is in the sleep mode). The magnitude of the idle currents drawn by the controller 152, the IR receiver 166, and other low-voltage circuitry of the motor drive unit 120 may be significantly smaller when these circuits are powered by the first nominal magnitude of the DC supply voltage V_{CC}.

The motor drive unit 120 further comprises a battery monitoring circuit 158 that receives the battery voltage V_{BATT} and provides a battery-monitor control signal V_{MON} representative of the magnitude of the battery voltage V_{BATT} to the controller 152. The battery monitoring circuit 158 may comprise for example a resistive voltage divider circuit (not shown) coupled in series between the battery voltage V_{BATT} and circuit common, such that the battery-monitor control signal V_{MON} is simply a scaled version of the battery voltage V_{BATT}. The controller 152 may include an analog-to-digital converter (ADC) for receiving and measuring the magnitude of the battery-monitor control signal V_{MON} to thus determine the magnitude of the battery voltage V_{BATT}. The battery monitoring circuit 158 may further comprise a controllable switch, e.g., a NPN bipolar junction transistor (not shown), coupled in series with the resistive divider. The controller 152 may be operable to render the controllable switch conductive, such that the battery-monitor control signal V_{MON} is representative of the magnitude of the battery voltage V_{BATT}, and to render the controllable switch non-conductive, such that the resistive divider does not conduct current and energy is conserved in the batteries 138.

According to an aspect of the present invention, the controller 152 is operable to determine that the magnitude of the battery voltage V_{BATT} is getting low in response to the battery-monitor control signal V_{MON} received from the battery monitoring circuit 158. Specifically, the controller 152 is operable to operate in a low-battery mode when the magnitude of the battery voltage V_{BATT} drops below a first predetermined battery-voltage threshold V_{B-TH1} (e.g., approximately 1.0 volts per battery). For example, the controller 152 may control the motor drive circuit 154 so that the motor 150 is operated at a reduced speed (e.g., at half speed) to reduce the instantaneous power requirements on the batteries 138 when the controller 152 is operating in the low-battery mode. This would serve as an indication to a consumer that the battery voltage V_{BATT} is low and the batteries 138 need to be changed.

When the magnitude of the battery voltage V_{BATT} drops below a second predetermined battery-voltage threshold V_{B-TH2} (less than the first predetermined battery-voltage threshold V_{B-TH1}, e.g., approximately 0.9 V per battery) while operating in the low-battery mode, the controller 152 may shut down electrical loads in the motor drive unit 120 (e.g., by disabling the IR receiver 166 and other low-voltage circuitry of the motor drive unit) and prevent movements of the cellular shade fabric 112 except to allow for at least one additional movement of the cellular shade fabric to the fully-open position P_{FULLY-OPEN}. Having the cellular shade fabric 112 at the fully-open position P_{FULLY-OPEN} allows for easy replacement of the batteries. The second predetermined battery-voltage threshold V_{B-TH2} may be sized to provide enough reserve energy in the batteries 138 to allow for the at least one additional movement of the cellular shade fabric 112 and the weighting element 116 to the fully-open position P_{FULLY-OPEN}.

When the magnitude of the battery voltage V_{BATT} drops below a third predetermined battery-voltage threshold V_{B-TH3} (less than the second predetermined battery-voltage threshold V_{B-TH2}, e.g., approximately 0.8 V per battery), the controller 152 may be operable to shut itself down such that no other circuits in the motor drive unit 120 consume any power in order to protect against any potential leakage of the batteries 138.

Referring back to FIG. 9, the motor drive unit 120 comprises an alternate (or supplemental) power source, such as a backup battery 159 (e.g., a long-lasting battery), which generates a backup supply voltage V_{BACKUP} (e.g., approximately 3.0 volts) for powering the controller 152. The DC supply voltage V_{CC} generated by the power supply 156 is coupled to the controller 152 via a first diode D₁, and the backup supply voltage V_{BACKUP} is coupled to the controller via a second diode D₂. The alternate power source provides the controller 152 with power when the batteries 138 are removed for replacement, or otherwise depleted, such that the position data relating to the position of the window treatment that is stored in the memory of the controller 152 is maintained. Alternatively, a large bus capacitor or an ultra-capacitor can be coupled to the controller 152 (rather than the backup battery 159), so that even when the batteries 138 are removed for replacement, an adequate charge will remain in the bus capacitor or ultra capacitor to maintain adequate voltage to keep the controller 152 charged for the period of time necessary to replace batteries 138 and thereby prevent loss of stored data in the memory of the controller.

These embodiments allow the motor drive unit 120 to keep track of the position of the weighting element 116 of the window treatment 110 even when the batteries 138 are removed and the window treatment is manually operated (i.e., pulled). In such embodiments, the controller 152 continues to receive signals from transmissive optical sensor circuit 155, even when the batteries 138 are removed. Because it remains powered, the controller 152 will continue to calculate the position of the window treatment 110 when manually adjusted. It should be pointed out that the window treatment 110 of the present invention allows a user at any time to manually adjust the position of the window treatment, and that the position of the window treatment is always calculated both when the window treatment is moved by the motor or manually.

Another feature of the invention is that the controller 152 is preferably arranged to prevent the motor drive circuit 154 from operating to lower the cellular shade fabric 112 until an upper limit for the fabric is reset after a loss of power, e.g., if the batteries 138 are depleted. Thus, the motor drive unit 120 will not lower from the current raised position in the event of power loss. The user will be required to raise the cellular shade fabric 112 to the fully-open position before being able to lower the shade fabric.

As shown in FIG. 9, the motor drive unit 120 comprises an internal temperature sensor 160 that is located adjacent the internal side 122 of the headrail 114 (i.e., a room-side temperature sensor), and a external temperature sensor 162 that is located adjacent the external side 124 of the headrail (i.e., a window-side temperature sensor). The room-side temperature sensor 160 is operable to measure an interior temperature T_{INT} inside the room in which the motorized window treatment 110 is installed, while the external temperature sensor 162 is operable to measure an exterior temperature T_{EXT} between the headrail 114 and the window 104. The motor drive unit 120 further comprises a photosensor 164, which is located adjacent the external side 124 of the headrail 114, and is directed to measure the amount of sunlight that may be shining on the window 104. Alternatively, the exterior (window-side) temperature sensor 162 may be implemented as a sensor label (external to the headrail 114 of the battery powered motorized window treatment 110) that is operable to be affixed to an inside surface of a window. The sensor label may be coupled to the motor drive unit 120 through low voltage wiring (not shown).

The controller 152 receives inputs from the internal temperature sensor 160, the external temperature sensor 162, and the photosensor 164. The controller 152 may operate in an eco-mode to control the position of the weighting element 116 and the cellular shade fabric 112 in response to the internal temperature sensor 160, the external temperature sensor 162, and the photosensor 164, so as to provide energy savings. When operating in the eco-mode, the controller 152 adjusts the amount of the window 104 covered by the cellular shade fabric 112 to attempt to save energy, for example, by reducing the amount of electrical energy consumed by other control systems in the building in which the motorized window treatment 110 is installed. For example, the controller 152 may adjust the present position P_{PRES} of the weighting element 116 to control the amount of daylight entering the room in which the motorized window treatment 110 is installed, such that lighting loads in the room may be turned off or dimmed to thus save energy. In addition, the controller 152 may adjust the present position P_{PRES} of the weighting element 116 to control the heat flow through the window 104 in order to lighten the load on a heating and/or cooling system, e.g., a heating, air-conditioning, and ventilation (HVAC) system, in the building in which the motorized window treatment 110 is installed.

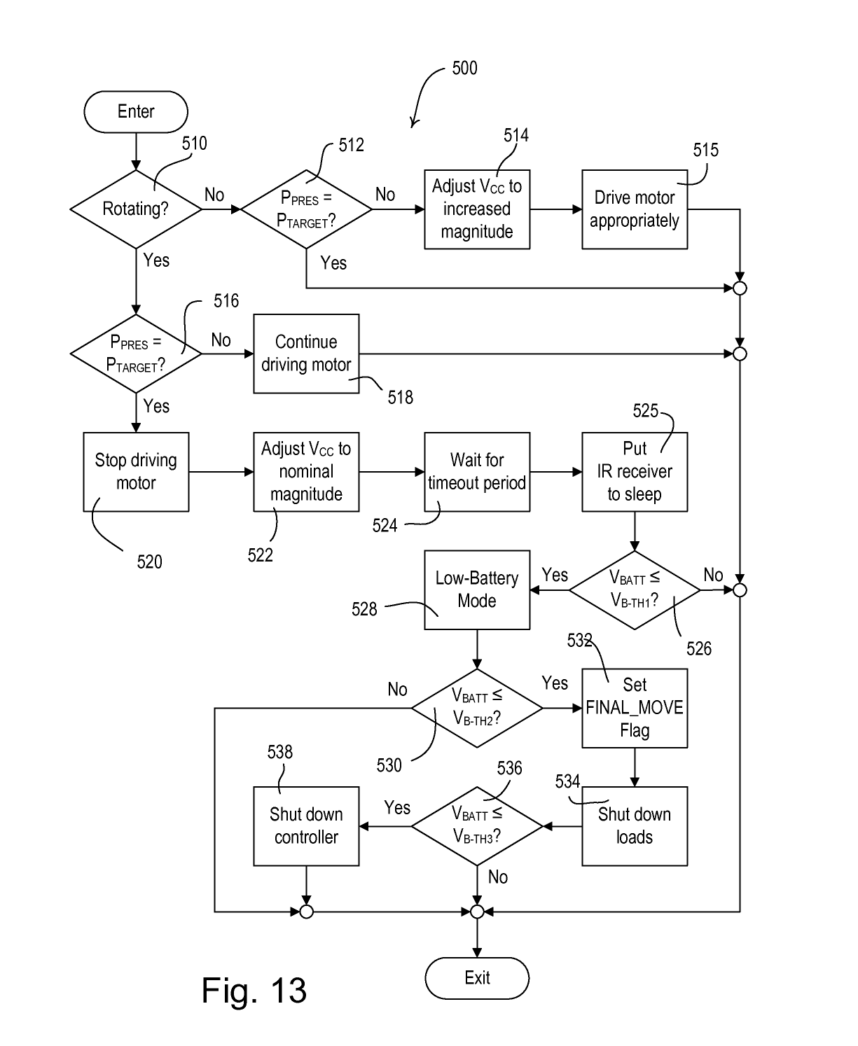

FIG. 13 is a simplified flowchart of a motor control procedure 300 executed periodically by the controller 152 (e.g., every two msec). If the motor 150 is not presently rotating at step 310 and the present position P_{PRES} is equal to the target position P_{TARGET} at step 312, the motor control procedure 300 simply exits without controlling the motor. However, if the motor 150 is not presently rotating at step 310 and the present position P_{PRES} is not equal to the target position P_{TARGET} at step 312, the controller 152 controls the voltage adjustment control signal V_{ADJ} to adjust the magnitude of the DC supply voltage V_{CC} to the increased magnitude (i.e., approximately 3.3 volts) at step 314. The controller 152 then begins to control the H-bridge drive circuit 154 to drive the motor 150 appropriately at step 315, so as to move the weighting element 116 towards the target position P_{TARGET}.

If the motor 150 is presently rotating at step 310, but the present position P_{PRES} is not yet equal to the target position P_{TARGET} at step 316, the controller 312 continues to drive the motor 150 appropriately at step 318 and the motor control procedure 300 exits. If the motor 150 is presently rotating at step 310 and the present position P_{PRES} is now equal to the target position P_{TARGET} at step 316, the controller 152 stops driving the motor at step 320 and controls the voltage adjustment control signal V_{ADJ} to adjust the magnitude of the DC supply voltage V_{CC} to the nominal magnitude (i.e., approximately 2.7 volts) at step 322. The controller 152 then waits for a timeout period (e.g., approximately 200 msec) at step 324, and puts the IR receiver 166 back to sleep at step 325.

As previously mentioned, the controller 152 operates in a low-battery mode when the magnitude of the battery voltage V_{BATT} is getting low. Specifically, if the magnitude of the battery voltage V_{BATT} has dropped below the first battery-voltage threshold V_{B-TH1} at step 326, the controller 152 begins at step 328 to operate in the low-battery mode during which the controller 152 will operate the motor at a reduced speed (i.e., at half speed). If the magnitude of the battery voltage V_{BATT} is less than or equal to the second battery-voltage threshold V_{B-TH2} at step 330, the controller 152 allows for one last movement of the cellular shade fabric 112 and the weighting element 116 to the fully-open position P_{FULLY-OPEN} by setting a FINAL_MOVE flag in memory at step 332. At step 334, the controller 152 shuts down all unnecessary loads of the motor drive unit 120 (e.g., the external temperature sensor 162, the photosensor 164, the internal temperature sensor 160, and the IR receiver 166) and prevents the motor 150 from moving the cellular shade fabric 112 and the weighting element 116 except for one last movement to the fully-open position P_{FULLY-OPEN}. If the magnitude of the battery voltage V_{BATT} is less than or equal to the third battery-voltage threshold V_{B-TH3} at step 336, the controller 152 shuts itself down at step 338 such that no other circuits in the motor drive unit 120 consume any power to thus protect against any potential leakage of the batteries 138. Otherwise, the motor control procedure 300 exits.

While the present invention has been described with reference to the battery-powered motorized window treatments having the cellular shade fabric 112, the concepts of the present invention could be applied to motors of other types of motorized window treatments, such as, for example, roller shades, draperies, Roman shades, Venetian blinds, and tensioned roller shade systems. An example of a roller shade system is described in greater detail in commonly-assigned U.S. Pat. No. 6,983,783, issued Jan. 10, 2006, entitled MOTORIZED SHADE CONTROL SYSTEM, the entire disclosure of which is hereby incorporated by reference. An example of a drapery system is described in greater detail in commonly-assigned U.S. Pat. No. 6,994,145, issued Feb. 7, 2006, entitled MOTORIZED DRAPERY PULL SYSTEM, the entire disclosure of which is hereby incorporated by reference. An example of a Roman shade system is described in greater detail in commonly-assigned U.S. patent application Ser. No. 12/784,096, filed Mar. 20, 2010, entitled ROMAN SHADE SYSTEM, the entire disclosure of which is hereby incorporated by reference. An example of a Venetian blind system is described in greater detail in commonly-assigned U.S. patent application Ser. No. 13/233,828, filed Sep. 15, 2011, entitled MOTORIZED VENETIAN BLIND SYSTEM, the entire disclosure of which is hereby incorporated by reference. An example of a tensioned roller shade system is described in greater detail in commonly-assigned U.S. Pat. No. 8,056,601, issued Nov. 15, 2011, entitled SELF-CONTAINED TENSIONED ROLLER SHADE SYSTEM, the entire disclosure of which is hereby incorporated by reference.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A motor drive unit for a motorized window treatment, the motorized window treatment including a covering material, a drive shaft, and at least one lift cord rotatably received around the drive shaft and extending to a bottom of the covering material for raising and lowering the covering material between a fully-open and fully-closed position and to any position intermediate the fully-open and fully-closed positions, the motor drive unit comprising:
a motor having an output shaft;
a first pulley coupled to the output shaft of the motor;
a second pulley coupled such that rotations of the second pulley result in rotations of the drive shaft; and
a flexible belt surrounding the first and second pulleys, such that rotations of the motor and the first pulley result in rotations of the second pulley, and thus the drive shaft, so as to raise and lower the covering material by rotating the motor.

2. The motor drive unit of claim 1, further comprising:
an enclosure for housing the motor, the first and second pulleys rotatably coupled with respect to the enclosure; and
at least one roller rotatably coupled with respect to the enclosure and contacting an outer surface of the belt.

3. The motor drive unit of claim 2, wherein the roller holds the belt against the first pulley to ensure that the belt and the first pulley have at least a predetermined angular contact length.

4. The motor drive unit of claim 3, wherein the angular contact length between the belt and the first pulley is approximately 136°.

5. The motor drive unit of claim 4, wherein the angular contact length between the belt and the first pulley is approximately 30° when the rollers are not included in the motor drive unit.

6. The motor drive unit of claim 2, further comprising:
an end portion adjacent the motor, the roller rotatably coupled to the end portion.

7. The motor drive unit of claim 2, further comprising:
two rollers rotatably coupled with respect to the enclosure and contacting an outer surface of the belt.

8. The motor drive unit of claim 1, wherein the second pulley has a larger diameter than the first pulley.

9. The motor drive unit of claim 1, wherein noises generated by the rotations of the motor are not coupled from the first pulley to the second pulley.

10. The motor drive unit of claim 1, further comprising:
a gear assembly coupled to the second pulley;
two output gears located on each side of the motor drive unit, each of the output gears coupled to one of two drive shafts; and
a coupling member coupled between the gear assembly and the output gears, such that rotations of the output shaft of the motor result in rotations of the drive shafts.

11. The motor drive unit of claim 1, wherein the belt comprises a toothed belt having teeth adapted to engage teeth of the first and second pulleys.

12. A gear assembly for a motor drive unit, the motor drive unit comprising a motor having an output shaft, the gear assembly comprising:
an end portion;
a first pulley adapted to be coupled to the output shaft of the motor adjacent the end portion and to rotate with respect to the end portion;
a second pulley;
a flexible belt surrounding the first and second pulleys, such that rotations of the motor and the first pulley result in rotations of the second pulley, the belt having teeth adapted to engage teeth of the first and second pulleys; and
a first roller rotatably coupled to the end portion and contacting an outer surface of the belt;
wherein the first roller holds the belt against the first pulley to ensure that the belt and the first pulley have at least a predetermined angular contact length.

13. The gear assembly of claim 12, wherein the angular contact length between the belt and the first pulley is approximately 136°.

14. The gear assembly of claim 12, further comprising:
a second roller rotatably coupled to the end portion and contacting an outer surface of the belt, such that both of the first and second rollers hold the belt against the first pulley.

15. A motorized window treatment comprising:
a covering material;
a drive shaft;
at least one lift cord rotatably received around the drive shaft and extending to a bottom end of the covering material;
a motor drive unit having a motor comprising an output shaft, the motor drive unit coupled to the drive shaft for raising and lowering the covering material in response to rotations of the motor; and
at least one battery for powering the motor drive unit;
wherein the motor drive unit further comprises a first pulley coupled to the output shaft of the motor, a second pulley coupled such that rotations of the second pulley result in rotations of the drive shaft, and a flexible belt surrounding the first and second pulleys, such that rotations of the motor and the first pulley result in rotations of the second pulley, and thus the drive shaft, so as to raise and lower the covering material by rotating the motor.

16. The motorized window treatment of claim 15, wherein the motor drive unit further comprises an enclosure for housing the motor and a roller, the first and second pulleys and the roller rotatably coupled with respect to the enclosure, the roller contacting an outer surface of the belt to hold the belt against the first pulley and ensure that the belt and the first pulley have at least a predetermined angular contact length.

17. The motorized window treatment of claim 16, wherein the angular contact length between the belt and the first pulley is approximately 136°.

18. The motorized window treatment of claim 16, wherein the motor drive unit comprises two rollers rotatably coupled with respect to the enclosure and contacting an outer surface of the belt.

19. The motorized window treatment of claim 15, wherein noises generated by the rotations of the motor are not coupled from the first pulley to the second pulley.

20. The motorized window treatment of claim 15, wherein the motor drive unit further comprises an output gear adapted to be coupled to the drive shaft, and a gear assembly coupled between the second pulley and the output gear.

21. The motorized window treatment of claim 15, wherein the belt comprises a toothed belt having teeth adapted to engage teeth of the first and second pulleys.

22. The motorized window treatment of claim 15, wherein the covering material comprises one of: a cellular shade fabric, a Roman shade fabric, and Venetian blinds.
